(19) United States
(12) Patent Application Publication
(10) Pub. No.: US 2015/0054188 A1
(43) Pub. Date: Feb. 26, 2015

(54) MOLD CLEANING APPARATUS AND MOLD CLEANING METHOD

(71) Applicant: KABUSHIKI KAISHA TOSHIBA, Tokyo (JP)

(72) Inventors: Takumi OTA, Kanagawa-ken (JP); Masayuki Hatano, Kanagawa-ken (JP)

(73) Assignee: KABUSHIKI KAISHA TOSHIBA, Tokyo (JP)

(21) Appl. No.: 14/089,010

(22) Filed: Nov. 25, 2013

(30) Foreign Application Priority Data
Aug. 23, 2013 (JP) 2013-173868

(51) Int. Cl. B29C 33/72

(52) U.S. Cl. CPC B29C 33/72
USPC 264/39; 425/225

(57) ABSTRACT

According to one embodiment, a mold cleaning apparatus includes a holding unit, a medium supply unit and a deformation unit. The holding unit is configured to hold a mold. The mold has a concave pattern feature. The concave pattern feature is provided on a first surface of a base plate. The medium supply unit is configured to supply a medium to the concave pattern feature. The deformation unit is configured to bend the mold such that the first surface of the mold is convex.

### CROSS-REFERENCE TO RELATED APPLICATIONS

This application is based upon and claims the benefit of priority from Japanese Patent Application No. 2013-173868, filed on Aug. 23, 2013; the entire contents of which are incorporated herein by reference.

### FIELD

Embodiments described herein relate generally to a mold cleaning apparatus and a mold cleaning method.

### BACKGROUND

For the formation of a pattern, a technology of transfer of a fine pattern called the imprint method using a mold provided with the concave-convex configuration of a pattern to be formed is drawing attention. The mold used in the imprint method is one in which a concave-convex pattern is formed on the surface of a base plate having light transmissivity of quartz or the like. The concave-convex pattern of the base plate is formed by forming a resist pattern on the surface of the base plate by the electron beam lithography method or the like and then etching the base plate.

In the pattern formation using a mold, a defect may occur in the pattern formed by transfer if a foreign body is attached to the concave-convex pattern. Thus, it is necessary to periodically clean the mold used. In the imprint method, it is important to remove the foreign body attached to the mold easily.

### BRIEF DESCRIPTION OF THE DRAWINGS

FIG. 1 is a schematic view illustrating the configuration of a mold cleaning apparatus according to a first embodiment;

FIG. 2A and FIG. 2B are schematic views illustrating the configuration of a mold;

FIG. 3A and FIG. 3B are schematic views illustrating the removal of a foreign body;

FIG. 4A to FIG. 4C are schematic views illustrating deformation units;

FIG. 5A and FIG. 5B are schematic views illustrating other deformation units;

FIG. 6 is a flow chart illustrating the mold cleaning method according to the embodiment;

FIG. 7 is a flow chart showing an example of the cleaning method; and

FIG. 8A to FIG. 8E are schematic cross-sectional views illustrating the imprint method.

### DETAILED DESCRIPTION

In general, according to one embodiment, a mold cleaning apparatus includes a holding unit, a medium supply unit and a deformation unit. The holding unit is configured to hold a mold. The mold has a concave pattern feature. The concave pattern feature is provided on a first surface of a base plate. The medium supply unit is configured to supply a medium to the concave pattern feature. The deformation unit is configured to bend the mold such that the first surface of the mold is convex.

Various embodiments will be described hereinafter with reference to the accompanying drawings. In the following description, identical components are marked with the same reference numerals, and a description of components once described is omitted as appropriate.

### First Embodiment

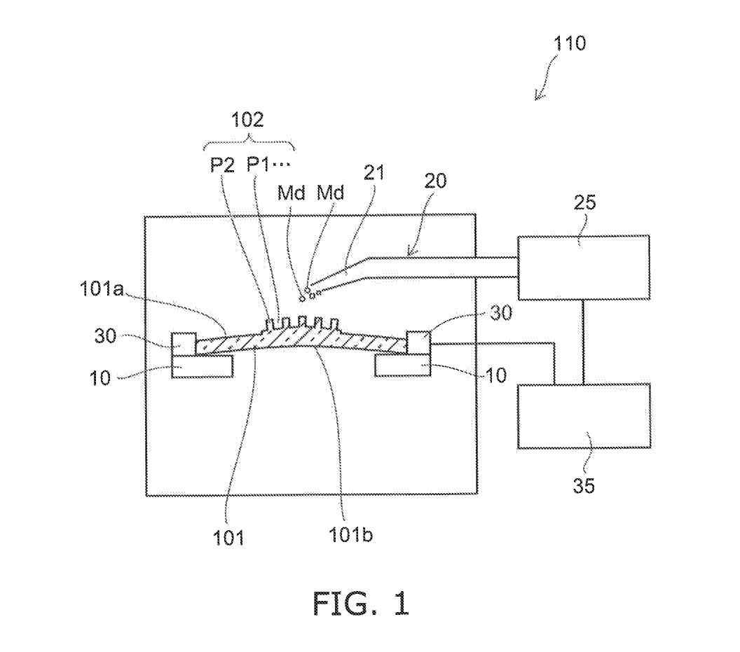

FIG. 1 is a schematic view illustrating the configuration of a mold cleaning apparatus according to a first embodiment.

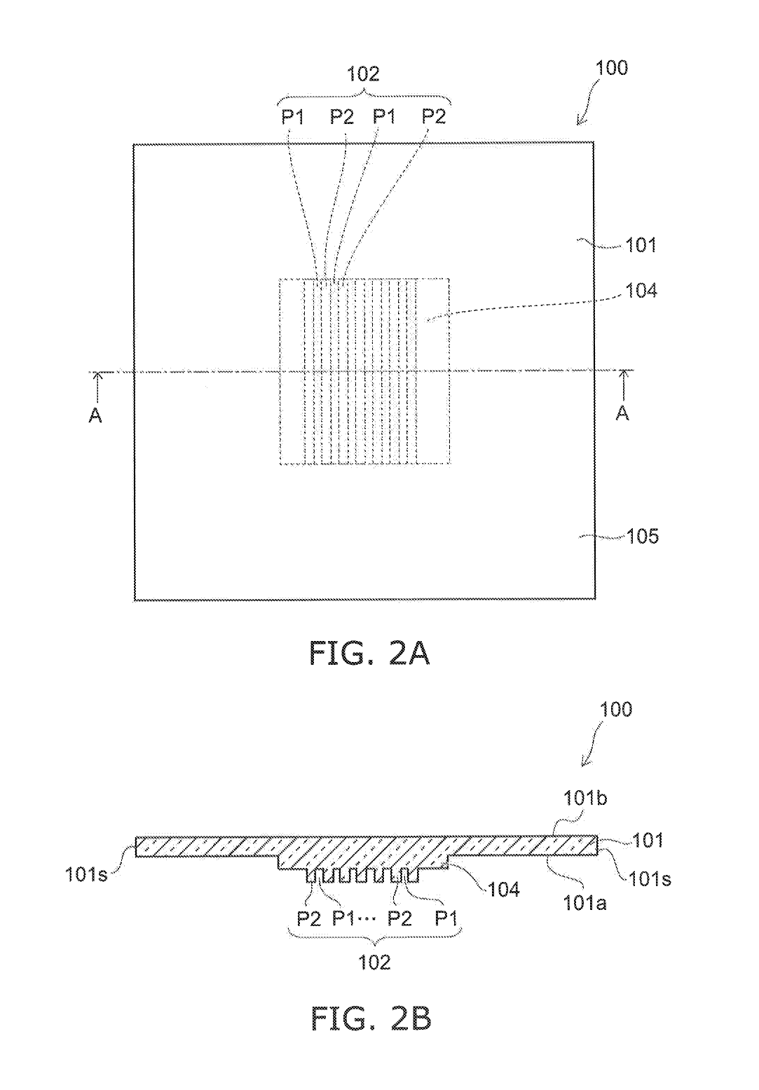

FIG. 2A and FIG. 2B are schematic views illustrating the configuration of a mold.

FIG. 2A is a plan view of a mold 100, and FIG. 2B is a cross-sectional view taken along line A-A of FIG. 2A.

As shown in FIG. 1, a mold cleaning apparatus 110 according to the embodiment is an apparatus that deans the mold 100 used in the imprint method. The mold cleaning apparatus 110 includes a holding unit 10, a medium supply unit 20, and a deformation unit 30.

The holding unit 10 is a portion (e.g. stage) that holds the mold 100. The medium supply unit 20 is a portion that supplies a medium Md that is at least one of a solid, a liquid, and a gas toward the mold 100.

The deformation unit 30 is a portion that bends the mold 100. The deformation unit 30 bends the mold 100 such that a first surface 101a of a base plate 101 is convex. FIG. 1 shows a state where the mold 100 is bent. Here, what the first surface 101a becomes convex means that the entire of the base plate 101 is convexly warped toward the first surface 101a side.

In the mold cleaning apparatus 110, the medium Md is supplied from the medium supply unit 20 toward a concave pattern feature P1 in a state where the mold 100 is bent by the deformation unit 30 such that the first surface 101a of the base plate 101 is convex. By bending the mold 100, the opening side of the concave pattern feature P1 is expanded, and it becomes easy to remove a foreign body in the concave pattern feature P1.

Here, an example of the mold 100 that is cleaned by the mold cleaning apparatus 110 is described.

As shown in FIGS. 2A and 2B, the mold 100 includes the base plate 101 and a pattern portion 102. The base plate 101 has the first surface 101a and a second surface 101b on the opposite side to the first surface 101a. The pattern portion 102 is provided on the first surface 101a, and has at least the concave pattern feature P1.

A base 104 is provided in a central portion of the first surface 101a of the base plate 101. The base 104 is provided convex with respect to the first surface 101a. The pattern portion 102 is provided on the base 104. The pattern portion 102 has at least one concave pattern feature P1. The concave pattern feature P1 is provided in a line form extending in one direction, for example. The concave pattern feature P1 may be provided in an island form in which the shape of its opening is a circle, an ellipse, an oval, a rectangle, or the like.

In the case of having a plurality of concave pattern features P1, a convex pattern feature P2 is provided between adjacent two concave pattern features P1. The convex pattern feature P2 is provided in a line form extending in one direction, for example. The convex pattern feature P2 may be provided in a columnar shape.

The external shape in a planar view of the base plate 101 is a rectangle with a vertical size of approximately 150 millimeters (mm) and a horizontal size of approximately 150 mm, for example. The base plate 101 is provided with four side surfaces 101s. The external shape in a planar view of the base 104 is a rectangle with a vertical size of 32 mm and a horizontal size of 26 mm, for example. The height of the base 104 is approximately 30 micrometers (μm). The thickness of a portion of a concavity 103 of the base plate 101 where the base 104 is not provided is approximately not less than 1 mm and not more than 6 mm.

The depth of the concave pattern feature P1 is not less than 50 nanometers (nm) and not more than 70 nm, for example. The width of the concave pattern feature P1 is not less than 10 nm and not more than 20 nm, for example. The height of the convex pattern feature P2 is approximately not less than 50 nm and not more than 70 nm. The width of the convex pattern feature P2 is approximately not less than 10 nm and not more than 20 nm. The pattern portion 102 is provided with a line-and-space pattern formed of a plurality of convex pattern features P2 and a plurality of concave pattern features P1, for example.

In the mold cleaning apparatus 110 shown in FIG. 1, the holding unit 10 holds the mold 100 by attracting the base plate 101 by vacuum suction, for example. The holding unit 10 may hold the mold 100 by catching the base plate 101 from the upper and lower sides or the left and right sides.

Although not shown in FIG. 1, the mold cleaning apparatus 110 is provided with a transfer unit that transfers the mold 100 of a cleaning object. The transfer unit transfers the mold 100 of a cleaning object from the outside of the apparatus to the holding unit 10.

The medium supply unit 20 supplies the medium Md to the concave pattern feature P1 of the mold 100 held by the holding unit 10. The medium supply unit 20 has a nozzle 21, for example. The medium Md is at least one of a solid, a liquid, and a gas. As the solid, abrasive grains of a ceramic are used, for example. As the liquid, an acid or alkali cleaning agent and ultrapure water (resistivity: approximately 18 MΩ·cm, for example) are used, for example. As the gas, an inert gas such as argon and a gas ionized by being provided with energy are used, for example.

The deformation unit 30 applies pressure to the mold 100 by various methods to bend the mold 100 such that the first surface 101a is convex. When the mold 100 is bent such that the first surface 101a is convex, the opening side of the concave pattern feature P1 provided on the first surface 101a is expanded as compared to when the mold 100 is not bent. Thus, even when a foreign body has got in the concave pattern feature P1, it is easy to remove the foreign body by the opening side of the concave pattern feature P1 being expanded.

The mold cleaning apparatus 110 further includes a medium control unit 25, a deformation control unit 35, and a processing chamber 40. The medium control unit 25 controls the supply amount, the supply timing, etc. of the medium Md supplied from the nozzle 21 of the medium supply unit 20. The deformation control unit 35 controls the deformation unit 30 to adjust the amount of deformation of the mold 100.

The processing chamber 40 is provided at least below the mold 100 held by the holding unit 10 and the nozzle 21 of the medium supply unit 20. In the embodiment, the processing chamber 40 is provided so as to surround the holding unit 10, the medium supply unit 20, and the deformation unit 30. The processing chamber 40 serves to receive the medium Md supplied from the medium supply unit 20.

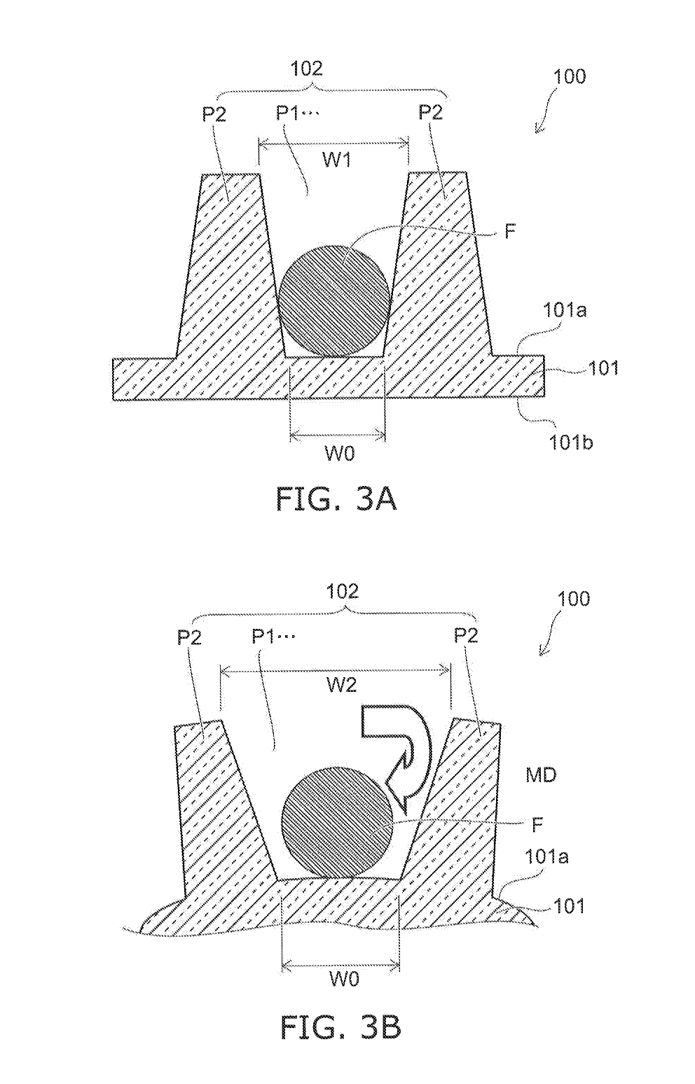

FIG. 3A and FIG. 3B are schematic views illustrating the removal of a foreign body.

FIG. 3A shows a state where a foreign body F has got in the concave pattern feature P1 of the mold 100. FIG. 3B shows a state where the mold 100 is bent.

As shown in FIG. 3A, the width W1 of the opening side of the concave pattern feature P1 of the mold 100 is wider than the width W0 of the bottom side of the concave pattern feature P1. In other words, the width of the convex pattern feature P2 is provided with a tapered shape that becomes narrower with distance from the base plate 101 side. Accordingly, the width of the concave pattern feature P1 becomes narrower from the opening side toward the bottom side. Therefore, the foreign body F that has got in from the opening side of the concave pattern feature P1 is likely to get in the concave pattern feature P1.

When the foreign body F has got in the concave pattern feature P1, sufficient cleaning using the medium Md is difficult. In particular, in cleaning using a medium Md not having the property of dissolving the foreign body F, it is very difficult to remove the foreign body F that has got in the concave pattern feature P1.

Thus, in the embodiment, as shown in FIG. 3B, the mold 100 is bent such that the first surface 101a of the base plate 101 is convex. Thereby, the width W2 of the opening side of the concave pattern feature P1 becomes wider than the width W1 shown in FIG. 3A. When the opening side of the concave pattern feature P1 is expanded, the getting in of the foreign body F in the concave pattern feature P1 is relaxed. By supplying the medium Md into the concave pattern feature P1 in this state, the foreign body F is easily removed from the concave pattern feature P1.

In the cleaning, energy such as plasma may be supplied in addition to supplying the medium Md. By the opening side of the concave pattern feature P1 being expanded, the probability with which energy such as plasma gets in is increased. Thereby, a space for shifting the foreign body F in the direction in which the medium Md flows can be created.

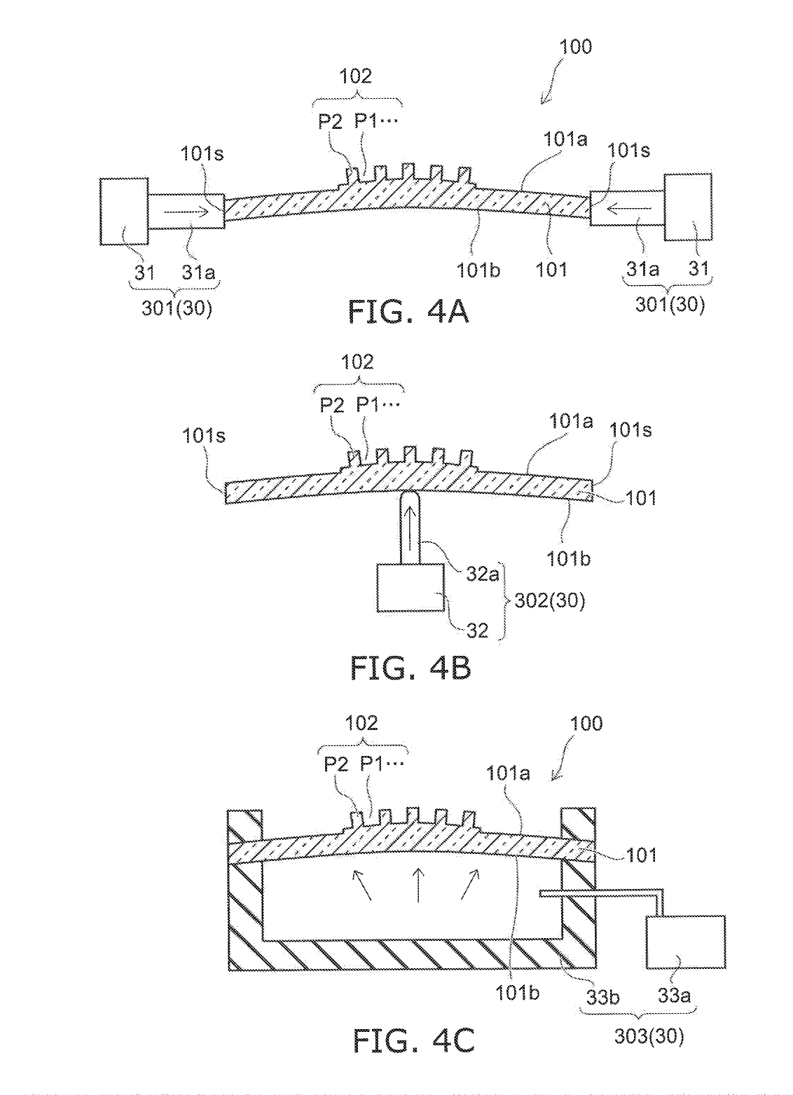

FIG. 4A to FIG. 4C are schematic views illustrating deformation units.

The deformation unit 30 shown in FIG. 4A includes an actuator 31 that is a pressing unit 301 and a push rod 31a. The actuator 31 causes the push rod 31a to move forward and backward. The push rod 31a is disposed to oppose the side surface 101s of the base plate 101 of the mold 100. The push rod 31a is disposed to oppose each of two opposing side surfaces 101s out of the four side surfaces 101s of the base plate 101, for example. The push rod 31a may be disposed to oppose each of the four side surfaces 101s.

The mold cleaning apparatus 110 adjusts the pressure applied to the side surface 101s of the base plate 101 from the push rod 31a via the actuator 31, and bends the mold 100 such that the first surface 101a is convex. In the case where the concave pattern feature P1 extends in one direction (line and space), the push rod 31a pushes two side surfaces 101s opposing each other in a direction orthogonal to the one direction in which the concave pattern feature P1 extends, for example. Thereby, the opening side of the concave pattern feature P1 extending in one direction is effectively expanded.

The deformation unit 30 shown in FIG. 4B includes an actuator 32 that is a pressing unit 302 and a push rod 32a. The actuator 32 causes the push rod 32a to move forward and backward. The push rod 32a is disposed on the second surface 101b side of the base plate 101. The actuator 32 moves the push rod 32a to bring the tip of the push rod 32a into contact with the second surface 101b of the base plate 101. The actuator 32 adjusts the amount of rise of the push rod 32a and presses the second surface 101b of the base plate 101 to the first surface 101a side. The mold 100 is bent with center at the position with which the push rod 32a is in contact. The mold 100 is bent such that the first surface 101a is convex.

The mold cleaning apparatus 110 may adjust the contact position of the push rod 32a with the second surface 101b. In the region of the pattern portion 102, the position in the concave pattern feature P1 where the foreign body F has got in is detected beforehand, for example. Then, the push rod 32a is moved to the second surface 101b located below the concave pattern feature P1 where the foreign body F has got in, and the second surface 101b is pressed by the push rod 32a.

The width of the opening side of the concave pattern feature P1 becomes widest in the position above the push rod 32a. Thus, by using the push rod 32a to press the second surface 101b located below the concave pattern feature P1 where the foreign body F has got in, the opening side of the concave pattern feature P1 where the foreign body F has got in is sufficiently expanded. Thereby, the foreign body F is easily removed.

The deformation unit 30 shown in FIG. 4C includes a pressure adjustment unit 33. The pressure adjustment unit 33 is a means for making the pressure on the second surface 101b side of the base plate 101 of the mold 100 higher than the pressure on the first surface 101a side.

The pressure adjustment unit 33 includes a pressure control unit 33a and a barrier wall unit 33b. The barrier wall unit 33b is a container for sealing the space on the second surface 101b side of the base plate 101 of the mold 100. The first surface 101a side of the base plate 101 is at atmospheric pressure, for example.

The pressure control unit 33a sends air into the barrier wall unit 33b, for example. Thereby, the pressure in the sealed space created by the barrier wall unit 33b is increased. When the pressure on the second surface 101b side of the base plate 101 has become higher than the pressure on the first surface 101a side, the mold 100 is bent such that the first surface 101a is convex.

The mold cleaning apparatus 110 controls the pressure adjustment unit 33 to adjust the pressure in the barrier wall unit 33b. Thereby, the amount of bending of the mold 100 is controlled.

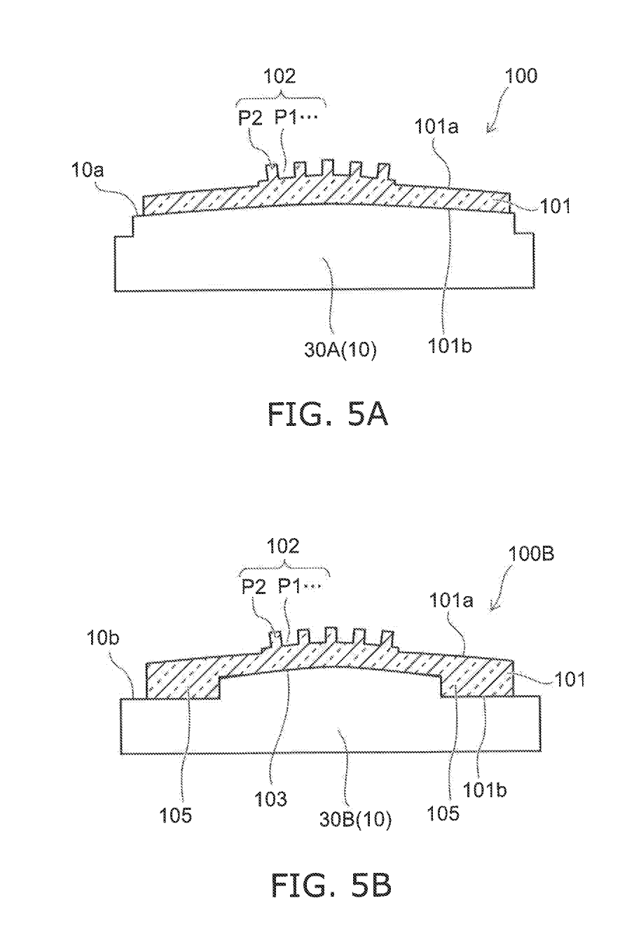

FIG. 5A and FIG. 5B are schematic views illustrating other deformation units.

In the examples shown in FIG. 5A and FIG. 5B, deformation units 30A and 30B are provided integrally with the holding unit 10. The deformation unit 30A (the holding unit 10) shown in FIG. 5A holds the mold 100 by vacuum suction. The deformation unit 30A (the holding unit 10) has an upper surface 10a. The second surface 101b of the base plate 101 of the mold 100 is attracted to the upper surface 10a.

The upper surface 10a is provided in a convex form. Therefore, when the mold 100 is attracted and held at the deformation unit 30A (the holding unit 10), the second surface 101b is closely attached along the convex form of the upper surface 10a by the attraction force, and the mold 100 is bent such that the first surface 101a is convex. In the deformation unit 30A, the amount of bending of the mold 100 is defined by the convex form of the upper surface 10a.

The deformation unit 30B (the holding unit 10) shown in FIG. 5B holds a mold 100B by vacuum suction. The mold 100B has a concavity 103 in a central portion of the base plate 101. The surroundings of the concavity 103 of the base plate 101 are a peripheral portion 105. The thickness of the concavity 103 is thinner than the thickness of the peripheral portion 105.

The deformation unit 30B (the holding unit 10) has an upper surface 10b and a convex surface 10c. The upper surface 10b is in contact with the peripheral portion 105 of the mold 100B. The convex surface 10c is in contact with the concavity 103 of the mold 100B. When the mold 100B is attracted and held at the deformation unit 30B (the holding unit 10), the concavity 103 is closely attached along the convex surface 10c by the attraction force, and the mold 100B is bent such that the first surface 101a is convex. In the deformation unit 30B, the amount of bending of the mold 100 is defined by the form of the convex surface 10c.

The mold cleaning apparatus 110 performs cleaning in a state where the mold 100 is bent by any of the deformation units 30 and 30B shown in FIG. 4A to FIG. 4C, FIG. 5A, and FIG. 5B. Thereby, the foreign body F that has got in the concave pattern feature P1 is easily removed.

### Second Embodiment

Next, a mold cleaning method according to a second embodiment is described.

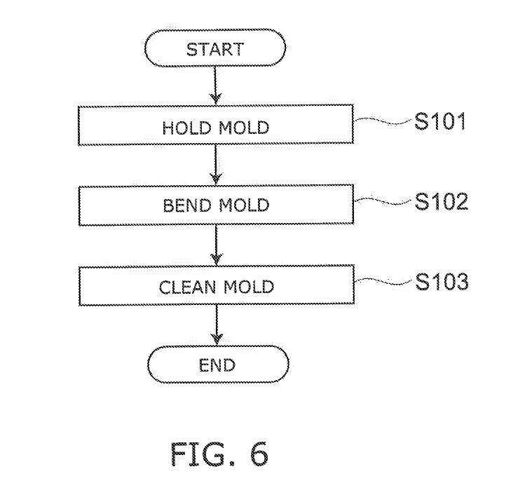

FIG. 6 is a flow chart illustrating the mold cleaning method according to the embodiment.

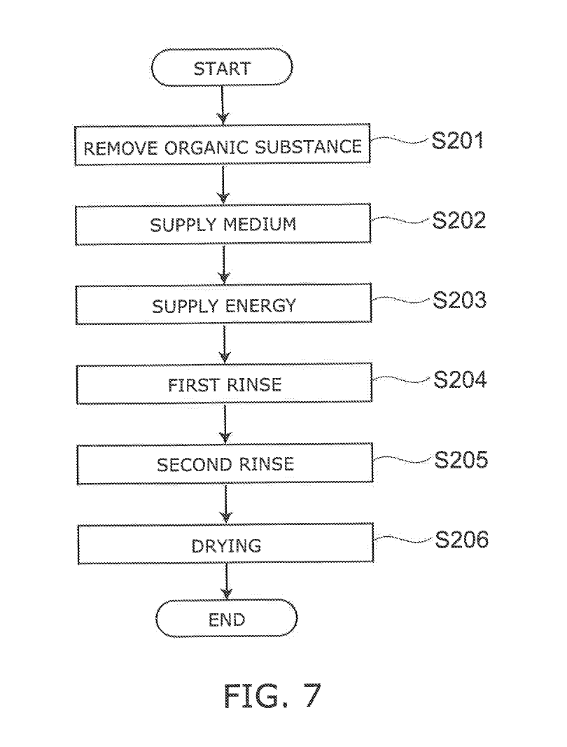

FIG. 7 is a flow chart showing an example of the cleaning method.

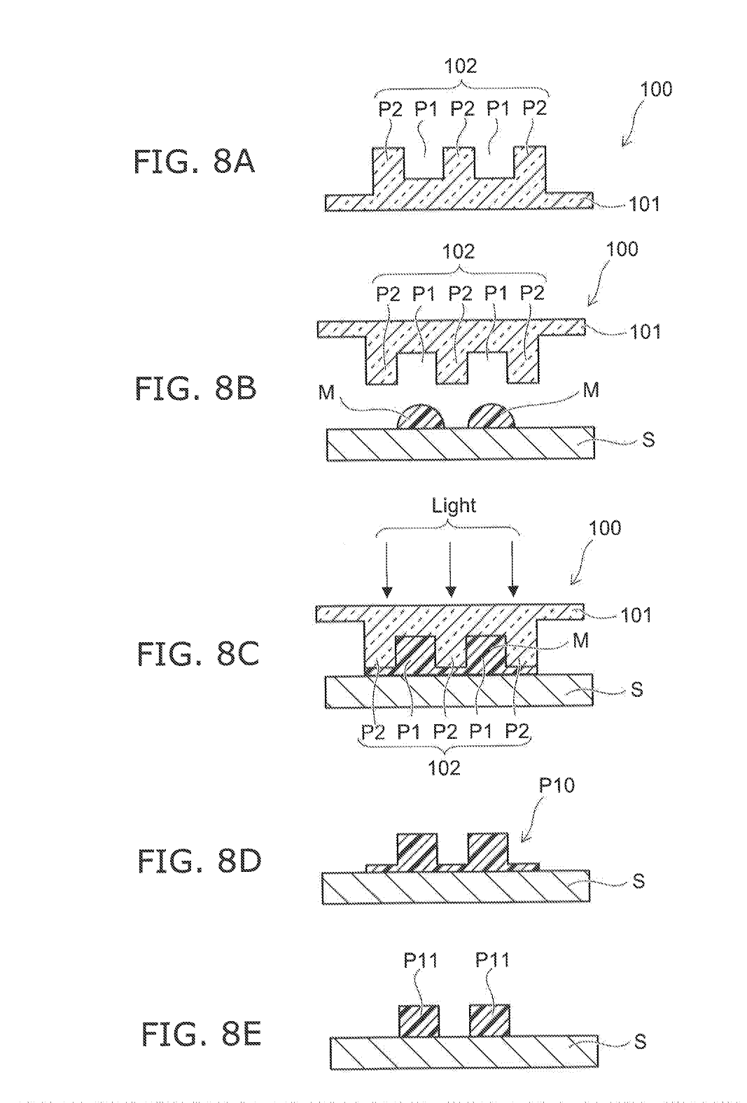

FIG. 8A to FIG. 8E are schematic cross-sectional views illustrating the imprint method.

Before the mold cleaning method according to the embodiment is described, the imprint method using a mold is described.

First, as shown in FIG. 8A, the mold 100 is prepared. The mold 100 includes the base plate 101 made of a light transmissive material such as quartz and the pattern portion 102 provided on the base plate 101. The pattern portion 102 is formed by forming a resist pattern on the base plate 101 by the electron beam lithography method or the like and then performing etching. At least the concave pattern feature P1 is included in the pattern portion 102.

Next, as shown in FIG. 8B, a material M having photocurability is applied onto a substrate S. The material M is dropped onto the substrate S by the ink jet method, for example. Then, as shown in FIG. 8C, the pattern portion 102 of the mold 100 is brought into contact with the material M on the substrate S. The material M is put into the concave pattern feature P1 of the mold 100 by capillarity.

Next, as shown in FIG. 8C, light (e.g. ultraviolet light) is applied from the back surface side of the mold 100 (the side where the pattern portion 102 is not formed). The light passes through the mold 100 and reaches the material M. Thereby, the material M is cured. After the material M is cured, the mold 100 is removed.

When the mold 100 has been removed, as shown in FIG. 8D, a transfer pattern P10 in which the pattern configuration of the pattern portion 102 is inverted is formed on the substrate S. Next, the remaining film provided on the substrate S side of the transfer pattern P10 is removed by RIE (reactive ion etching), for example. Thereby, as shown in FIG. 8E, convex pattern features P11 are formed on the substrate S.

In the imprint method, the concave-convex configuration of the pattern portion 102 of the mold 100 is transferred to the material M by performing the processes shown in FIG. 8B to FIG. 8E repeatedly. Thereby, an identical pattern is formed repeatedly.

As described above, in the method for forming a pattern by the imprint method, since the mold 100 and the material M come into contact, the material M may be attached as the foreign body F in the concave pattern feature P1 of the mold 100. The foreign body F attached onto the substrate S may move to the mold 100 side. If the foreign body F is attached to the mold 100, a reduction in yield may be caused by the influence of the foreign body F when a pattern is formed by the imprint method. Thus, it is necessary to clean the mold 100 periodically.

Here, as a cleaning method, a method is performed in which a foreign body F made of an organic substance such as a resin is dissolved using a mixed liquid of sulfuric acid and hydrogen peroxide water, then rising is performed with an alkali solution or pure water, and finally the remaining chemical liquid is scattered off to perform drying. There is also a physical cleaning method in which a gas is used to change a liquid to a mist form and the mist is sprayed to remove the foreign body F. Furthermore, there is also a method using ozone water or a gas that produces a redox reaction with resin (e.g. oxygen, hydrogen, and an activated mixed gas containing these). However, it is difficult to surely remove the foreign body F that has got in the concave pattern feature P1.

Next, the mold cleaning method according to the embodiment is described.

As shown in FIG. 6, the mold cleaning method according to the embodiment includes the holding of a mold (step S101), the bending of the mold (step S102), and the cleaning of the mold (step S103).

In the holding of a mold (step S101), the mold 100 is held at the holding unit 10. In the bending of the mold (step S102), the mold 100 is bent such that the first surface 101a is convex. The cleaning of the mold (step S103) includes supplying the medium Md to the concave pattern feature P1 in a state where the mold 100 is bent.

Here, to bend the mold 100, any of the means shown in FIG. 4A to FIG. 4C, FIG. 5A, and FIG. 5B may be used, for example.

Next, an example of the cleaning method is described.

As shown in FIG. 7, the mold cleaning method according to the embodiment includes the removal of an organic substance (step S201), the supply of a medium (step S202), the supply of energy (step S203), a first rinse (step S204), a second rinse (step S205), and drying (step S206).

In the removal of an organic substance (step S201), the processing of cleaning the mold 100 with a mixed liquid of sulfuric acid and hydrogen peroxide water is performed. Thereby, the organic substance adhering to the mold 100 is removed.

In the supply of a medium (step S202), the processing of supplying the medium Md to the concave pattern feature P1 of the mold 100 is performed. The medium Md is at least one of a liquid and a gas. As the liquid, ultrapure water (resistivity: approximately 18 MΩ·cm, for example) and CO₂ water are used, for example. As the gas, an inert gas such as argon is used, for example.

Since in the supply of a medium (step S202) the mold 100 is bent such that the first surface 101a is convex, the medium Md can be caused to sufficiently seep in the concave pattern feature P1. The foreign body F that has got in the concave pattern feature P1 is easily removed.

In the supply of energy (step S203), the processing of supplying energy toward the mold 100 from the opposite side to the first surface 101a of the base plate 101 of the mold 100 is performed. The energy is one of an ultrasonic wave and laser light, for example. In the embodiment, the energy reaches the concave pattern feature P1 from the bottom surface 103b of the concavity 103 of the mold 100. The amount of energy is controlled by the amount of energy supplied and the distance between the energy supply source and the concave pattern feature P1.

The medium Md is activated by the energy irradiation. In the case where the energy is an ultrasonic wave, the medium Md is activated to cause cavitation, and by the cavitation the foreign body F that has got in the concave pattern feature P1 is pushed out to the opening side of the concave pattern feature P1, for example.

In the case where the energy is laser light, induced shock of the laser light to the medium Md is generated, and by the induced shock the foreign body F that has got in the concave pattern feature P1 is pushed out to the opening side of the concave pattern feature P1, for example. Thereby, the foreign body F is removed from the concave pattern feature P1.

In the first rinse (step S204), the processing of rinsing the mold 100 with an alkali solution is performed. Thereby, of the foreign bodies F pushed out of the concave pattern feature P1, foreign bodies re-attached to the surface of the mold 100 are surely removed.

In the second rinse (step S205), the processing of rinsing the mold 100 with pure water is performed, for example. Thereby, the alkali solution adhering to the mold 100 is removed. In the second rinse, rinsing is performed using a solution that is more neutral than the alkalinity of the alkali solution used in the first rinse (step S204). Ultrapure water is most preferable.

In the drying (step S206), the processing of drying the pure water, for example, used in the second rinse is performed. By these processes, the cleaning of the mold 100 is performed.

In the supply of a medium (step S202) out of the processes shown in step S201 to step S206, the processing is performed in a state where the mold 100 is bent. In at least one process other than the supply of a medium (step S202) out of the processes shown in step S201 to step S206, the processing may be performed in a state where the mold 100 is bent.

In such a mold cleaning method according to the embodiment, the width of the opening side of the concave pattern feature P1 is widened by bending the mold 100. By supplying the medium Md in this state, the foreign body F that has got in the concave pattern feature P1 is easily removed.

As described above, the mold cleaning apparatus 110 and the mold cleaning method according to the embodiment can easily remove a foreign body attached to a mold.

Hereinabove, embodiments and modification examples thereof are described. However, the invention is not limited to these examples. For example, although the mold cleaning apparatus 110 described above may be an isolated apparatus as a cleaning apparatus, it may be incorporated in an imprint apparatus. The mold 100 of a cleaning object may also be one using a material having flexibility made of a resin or the like, as well as one using a hard material such as quartz as the base plate 101. Furthermore, one skilled in the art may appropriately make additions, removals, and design modifications of components to the embodiments described above, and may appropriately combine features of the embodiments; such modifications also are included in the scope of the invention to the extent that the spirit of the invention is included.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A mold cleaning apparatus comprising:
a holding unit configured to hold a mold, the mold having a concave pattern feature, the concave pattern feature being provided on a first surface of a base plate;
a medium supply unit configured to supply a medium to the concave pattern feature; and
a deformation unit configured to bend the mold such that the first surface of the mold is convex.

2. The apparatus according to claim 1, wherein
the deformation unit includes a pressing unit,
the pressing unit pressing the base plate of the mold.

3. The apparatus according to claim 2, wherein
the base plate is a rectangle having four side surfaces,
the pressing unit pressing two opposing side surfaces out of the four side surfaces of the base plate.

4. The apparatus according to claim 3, wherein
the concave pattern feature extends in one direction,
the pressing unit pressing the two side surfaces opposing each other in a direction orthogonal to the one direction.

5. The apparatus according to claim 2, wherein
the base plate is a rectangle having four side surfaces,
the pressing unit pressing the four side surfaces of the base plate.

6. The apparatus according to claim 1, wherein
the deformation unit includes a pressing unit,
the pressing unit pressing a second surface on an opposite side to the first surface of the base plate.

7. The apparatus according to claim 6, wherein the pressing unit includes a push rod configured to press the second surface.

8. The apparatus according to claim 1, wherein
the deformation unit includes a pressure adjustment unit,
the pressure adjustment unit making a pressure on a second surface side on an opposite side to the first surface of the base plate higher than a pressure on the first surface side of the base plate.

9. A mold cleaning method for cleaning a mold, the mold having a concave pattern feature, the concave pattern feature being provided on a first surface of a base plate, the method comprising:
holding the mold;
bending the mold such that the first surface is convex; and
supplying a medium to the concave pattern feature in a state where the mold is bent.

10. The method according to claim 9, wherein the bending the mold includes pressing a side surface of a base plate of the mold.

11. The method according to claim 9, wherein
the base plate is a rectangle having four side surfaces,
the bending the mold including pressing two opposing side surfaces out of the four side surfaces of the base plate.

12. The method according to claim 9, wherein
the concave pattern feature extends in one direction,
the bending the mold including pressing the two side surfaces opposing each other in a direction orthogonal to the one direction.

13. The method according to claim 9, wherein
the base plate is a rectangle having four side surfaces and
the bending the mold including pressing the four side surfaces of the base plate.

14. The method according to claim 9, wherein the bending the mold includes pressing a second surface on an opposite side to the first surface of the base plate.

15. The method according to claim 9, wherein the bending the mold includes making a pressure on a second surface side on an opposite side to the first surface of the base plate higher than a pressure on the first surface side of the base plate.
